(19) United States
(12) Patent Application Publication
(10) Pub. No.: US 2014/0074857 A1
(43) Pub. Date: Mar. 13, 2014

(54) WEIGHTED RANKING OF VIDEO DATA

(71) Applicants: SU LIU, Austin, TX (US); Elizabeth Vera Woodward, Austin, TX (US); Shunguo Yan, Austin, TX (US)

(72) Inventors: SU LIU, Austin, TX (US); Elizabeth Vera Woodward, Austin, TX (US); Shunguo Yan, Austin, TX (US)

(73) Assignee: International Business Machines Corporation, Armonk, NY (US)

(21) Appl. No.: 13/607,124

(22) Filed: Sep. 7, 2012

(51) Int. Cl. G06F 17/30

(52) U.S. Cl. 707/748; 707/E17.044

(57) ABSTRACT

A method, system, and computer program product for weighted ranking of video data are provided in the illustrative embodiments. A weight is assigned to an aspect of the video data. A weight is assigned to a person expected to feature in the video data. A weight of the video data is computed, the weight of the video data being a factor of the weight assigned the aspect and the weight assigned the person. A ranking of the video data is computed using the weight computed for the video data.

### BACKGROUND

1. Technical Field

The present invention relates generally to a method, system, and computer program product for organizing video content. More particularly, the present invention relates to a method, system, and computer program product for weighted ranking of video data.

2. Description of the Related Art

The amount of information contained in a video is enormous. Given the explosive growth in the volume of video data that is created, stored, and distributed every day, people cannot really view every available video, even if they wanted.

Just as prioritizing activities is necessary to fit some activities in a limited amount of time, some way of ordering videos is needed to rank the available video data.

### SUMMARY

The illustrative embodiments provide a method, system, and computer program product for weighted ranking of video data. An embodiment assigns a weight to an aspect of the video data. The embodiment assigns a weight to a person expected to feature in the video data. The embodiment computes a weight of the video data, the weight of the video data being a factor of the weight assigned the aspect and the weight assigned the person. The embodiment computes a ranking of the video data using the weight computed for the video data.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a table that can be used as a part of a weighting configuration in accordance with an illustrative embodiment;

FIG. 4 depicts another table that can be used as another part of a weighting configuration in accordance with an illustrative embodiment;

FIG. 5 depicts another table that can be used as another part of a weighting configuration in accordance with an illustrative embodiment;

FIG. 6 depicts a block diagram of an application for weighted ranking of video data in accordance with an illustrative embodiment; and

FIG. 7 depicts a flowchart of an example process of weighted ranking of video data in accordance with an illustrative embodiment.

### DETAILED DESCRIPTION

The illustrative embodiments recognize that video data includes a vast variety of information. For example, a typical video can include several aspects, such as people, places, things, text, graphics, background, foreground, and settings. The illustrative embodiments recognize that presently available video search and ranking methods only use video metadata, such as the author, the title, or the description, to assess the contents of the video and rank the video in some order for viewing.

Some existing video ranking technologies also use the text content associated with the video, such as closed captions or subtitles, and informative description of the video, for performing the ranking. Online video sharing websites, such as YouTube™ also use viewers' comments, such as viewer-provided ranking, tags, or recommendations, in their video search and ranking functions (YouTube is a trademark or service mark of YouTube, LLC, in the United States and in other countries). For example, YouTube looks at the number of comments added to a video to select a video to feature on their front page.

As video data becomes increasingly prevalent in social networks and business, the conventional video ranking methods have demonstrated their limitations. For example, the illustrative embodiments recognize that people or speakers in the videos may be critical in some videos and should be considered for video ranking. For example, the illustrative embodiments recognize that in a video, a portion where an executive delivers a speech may warrant more weight than another portion where other speakers are presenting. According to an illustrative embodiment, for a video that records a round table meeting with a company's executives, not only the content that was spoken or presented, but also who presented the content, when they presented it, and for what length of time, are some example people-related factors that should be accounted for in ranking the video.

The illustrative embodiments recognize that the presently available video ranking methods do not account for the relationship between persons and content present in the video data. The presently available methods for video ranking also do not account for relationships of those people or content with certain aspects of the video data that are not available in the metadata.

The illustrative embodiments used to describe the invention generally address and solve the above-described problems and other problems related to ranking videos. The illustrative embodiments provide a method, system, and computer program product for weighted ranking of video data.

An embodiment uses a weighting configuration to assign weights to certain characteristics of a given video data, such as to persons, content, various other aspects, and to relationships there-between, in the given video data. An embodiment uses default weighting functions, weighting functions specified for weighting a particular characteristics, different weighting functions for all or part of the video data, or a combination thereof, to compute a weighted ranking of video data.

An embodiment can perform weighted ranking of videos in a collection of videos. Another embodiment can perform weighted ranking of different parts of a single video. Another embodiment can perform weighted ranking of portions of different videos in a given collection. An embodiment can implement the functions of one or more embodiments described herein.

The illustrative embodiments are described with respect to certain type, language, or form of video data only as examples. Such descriptions are not intended to be limiting on the invention. For example, an illustrative embodiment can be implemented with respect to mixed-media data, or video data in any language, in a similar manner within the scope of the illustrative embodiments.

The illustrative embodiments are described with respect to certain data, data structures, file-systems, file names, directories, and paths only as examples. Such descriptions are not intended to be limiting on the invention. For example, an illustrative embodiment described with respect to a local application name and path can be implemented as an application on a remote path within the scope of the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

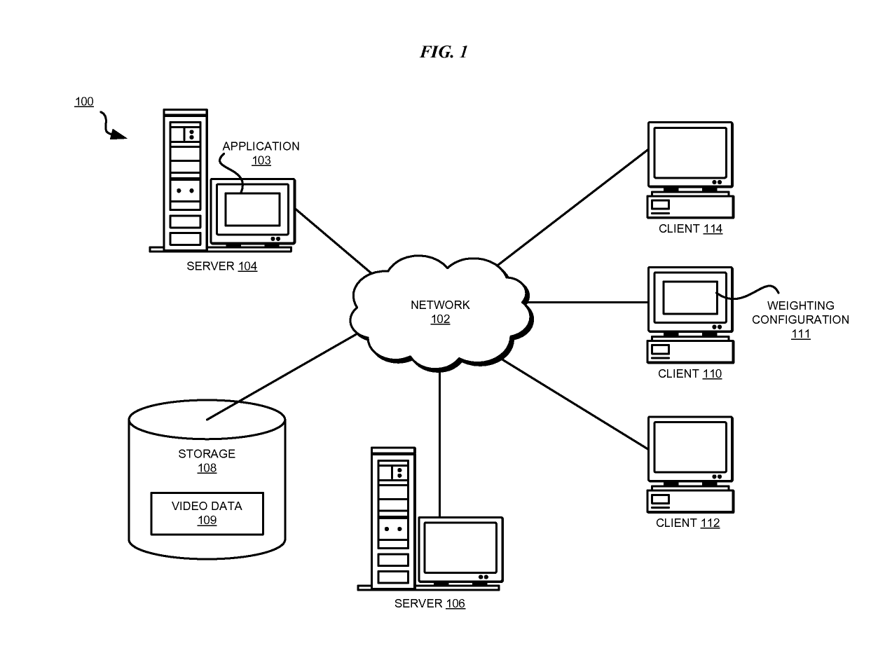

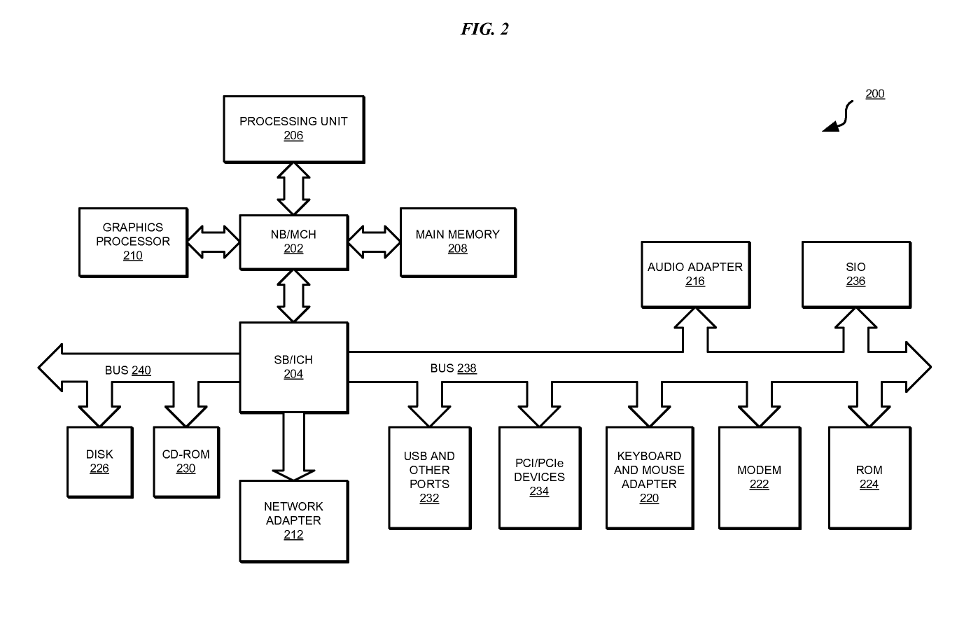

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that can be used in an embodiment. For example, server 104 includes application 103 that implements an embodiment. A data storage, such as storage 108, includes video data 109, which is usable for weighted rating in accordance with an embodiment. Weighting configuration 111 in client 110 is a set of one or more weighting parameters that can be configured for use in the weighted rating of an embodiment. Weighting configuration 111 or a part thereof can take any suitable form, including but not limited to one or more data structures, one or more records in a database, crowd-sourced information in any suitable form, or a combination thereof.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 103 in FIG. 1, and weighting configuration 111 in FIG. 1 in some implementations, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

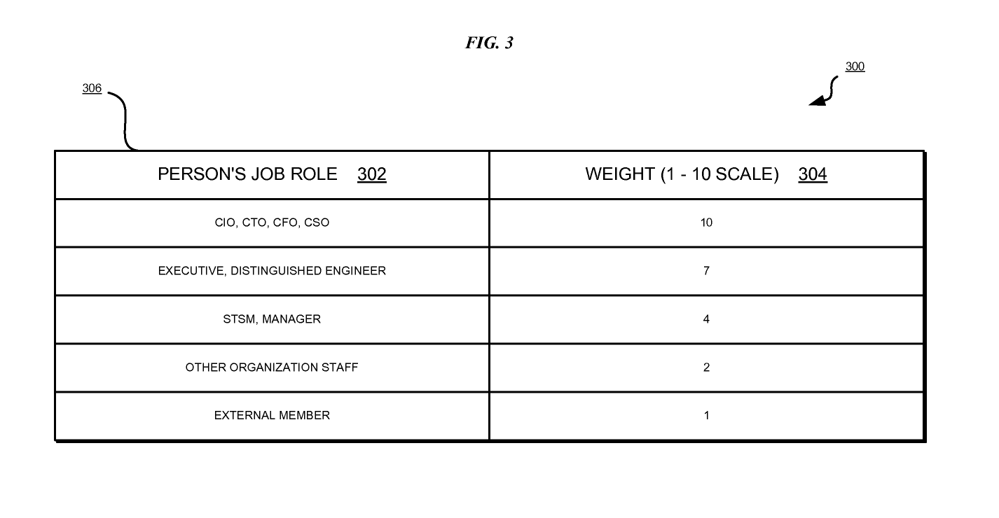

With reference to FIG. 3, this figure depicts a table that can be used as a part of a weighting configuration in accordance with an illustrative embodiment. Table 300 can be implemented as a part of weighting configuration 111 in FIG. 1.

Certain persons can be expected to appear in the video data being ranked. Depending on the purpose of the weighted ranking operation, videos or video portions containing certain persons may be ranked higher than other videos or portions. Any suitable technique can be used to identify a person in a given video. For example, existing technology for picture matching or face-recognition can be used to detect the presence or absence of a person in a video or a portion thereof. Furthermore, any suitable source may be used to obtain a comparative sample, such as a photograph, for picture matching or face recognition. For example, a person's picture may be obtained from a social network profile or an organization's personnel database.

In one embodiment, such persons may also have certain roles, positions, or capacities in an organization. Only as an example and without implying any limitation on the illustrative embodiments, table 300 depicts weighting of roles in order to weight the person performing that role. Column 302 lists the roles of the persons of interest, and column 304 lists the weights or significance that an embodiment should attribute to the corresponding roles in column 302.

In example table 300, according to row 306, a CIO/CTO/CFO/CSO role, and the person bearing that role, is to be given the highest weight among all persons appearing in the given video data. In other words, those videos or video portions, where a person holding that C-level position appears, are to be ranked using the weighting in row 306. Other persons (or roles) are allocated certain weights in a similar manner. According to the last row, an external member, such as a guest at a conference, has the least weight, and those videos or video portions, where such persons appear, are to be ranked using the weighting in the last row.

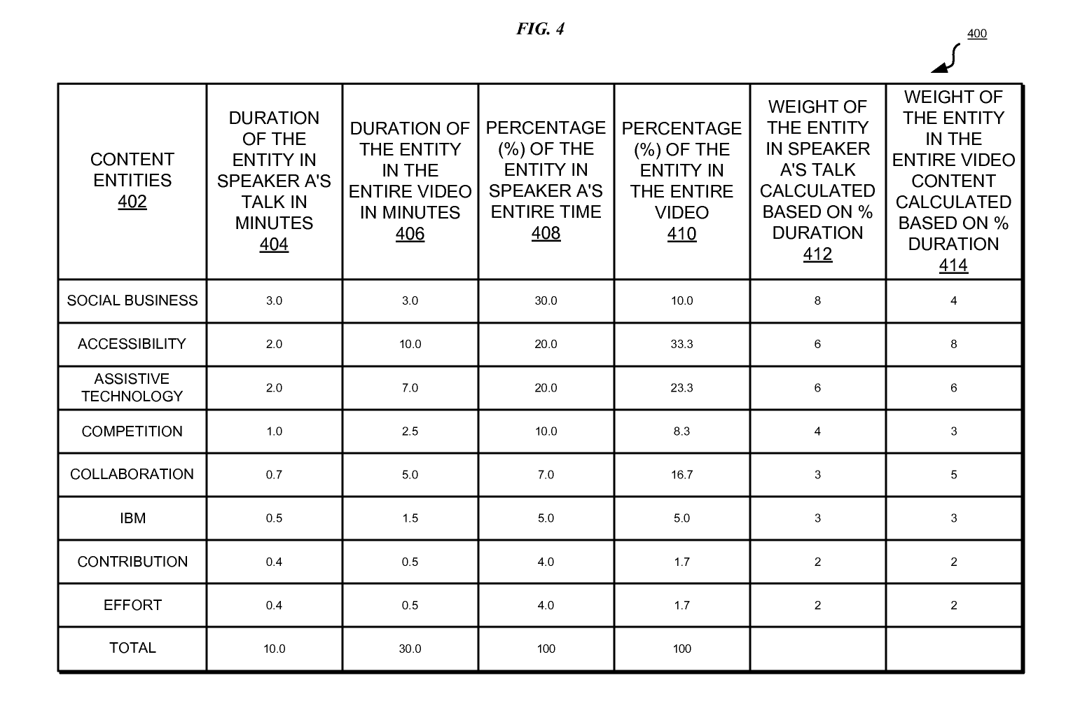

With reference to FIG. 4, this figure depicts another table that can be used as another part of a weighting configuration in accordance with an illustrative embodiment. Table 400 can be implemented as another part of weighting configuration 111 in FIG. 1, in conjunction with table 300 of FIG. 3.

According to an embodiment, the content delivered by, received by, discussed by, presented to, or attributed to a person or a role bearer is also used in conjunction with the role to rank the video data. Table 400 provides an example way in which weighting of content or content-fragments (collectively referred to as “content entities”) can be configured in a weighting configuration. Some examples of a content entity can be a word, a phrase, a sentence, a noun, a title, a reference, a subject, an action or activity, or para-phrased form thereof in one or more languages. Furthermore, a content entity can be available in any combination of text, audio, or video forms in the video data being ranked.

Table 400 provides an example weighting configuration for a person or role, such as a role identified under column 302 in row 306 in table 300 in FIG. 3. Assume that a person bearing a CIO role is featured in an example video, and that person is designated as “speaker A”. As an example, table 400 lists certain example content entities in column 402. The example video is analyzed for the presence of speaker A and where speaker A is associated with a content entity identified in column 402. For example, speaker A may be talking on various subjects or topics, including the content entities of column 402.

Columns 404, 406, 408, and 410 provide example analysis data from an example analysis of the example video. The example analysis or the resulting data is described only for the clarity of the description and not and a limitation on the illustrative embodiments. Those of ordinary skill in the art will be able to conceive from this disclosure many additional or different pieces of information and analyses that can be used for populating table 400 in a similar manner, and the same are contemplated within the scope of the illustrative embodiments.

For example, column 404 lists time durations in the example video that speaker A dedicated to the corresponding content entities identified in column 402. Column 406 lists total time durations in the example video when the corresponding content entities identified in column 402 were communicated. Column 408 lists percentages of times a corresponding content entity occupied in the total time. Column 410 lists as percentages of the entire run time of the example video, the total time durations in the example video when the corresponding content entities identified in column 402 were communicated.

Using a suitable function, such as multiplication of two or more values in table 400 with or without constant multipliers, an embodiment populates example columns 412 and 414. Columns 412 and 414 represent example weighting values that form a part of the weighting configuration according to an embodiment. For example, column 412 lists a weight an embodiment should attribute to a corresponding content entity in column 402 based on a factor of the values in columns 408 and some weight threshold or constant. For example, such a weighting is indicative of the importance that a person of certain value placed on a particular content entity during the example video. Accordingly, a user of the video can easily rank videos or video portions where certain persons deliver, receive, or otherwise communicate certain content. Furthermore, the weighted ranking can organize such videos or video portions in an increasing or decreasing order of the time the person of interest communicates the content of interest in proportion to other content.

As another example, column 412 lists a weight an embodiment should attribute to a corresponding content entity in column 402 based on a factor of the values in columns 410 and some weight threshold or constant. For example, such a weighting is indicative of the importance placed on a particular content entity during the example video. Accordingly, a user of the video can easily rank videos or video portions where certain content is communicated. Furthermore, the weighted ranking can organize such videos or video portions in an increasing or decreasing order of the time occupied to communicate the content of interest in proportion to other content.

An implementation can use any suitable function for calculating the weights in columns 412 and 414. In table 400, certain weights are attributed to certain percentage ranges for illustration purposes only. For example, a value of forty percent or greater is given a maximum weight of 10; a value between thirty-five and forty percent is given a weight of 9; a value between thirty and thirty-five percent is given a weight of 8; a value between twenty-five and thirty percent is given a weight of 7; a value between twenty and twenty-five percent is given a weight of 6; a value between fifteen and twenty percent is given a weight of 5; a value between ten and fifteen percent is given a weight of 4; a value between five and ten percent is given a weight of 3; a value between one and five percent is given a weight of 2; a value greater than zero but less than one percent is given a weight of 1; and a value of zero percent is given a weight of 0.

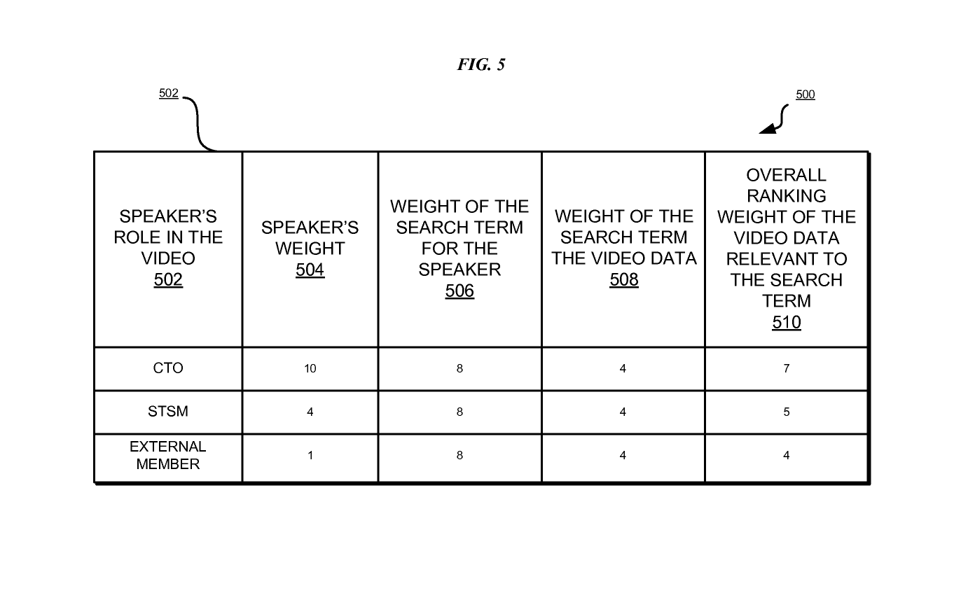

With reference to FIG. 5, this figure depicts another table that can be used as another part of a weighting configuration in accordance with an illustrative embodiment. Table 500 can be implemented as another part of weighting configuration 111 in FIG. 1, in conjunction with tables 300 of FIGS. 3 and 400 of FIG. 4.

Table 500 provides an example weighting configuration using which an embodiment can perform weighted ranking of a video or a video portion. Again, using a person or speaker's role and a content entity as examples, a weight for ranking the overall video or video portion is calculated based on a person or role's weight in the given video data as described earlier, a content entity's weight in each person or role portions in the given video data, and the relevance of the video data to a given search term.

Table 500 shows an example overall weight for ranking a given video using the example depicted in table 400. Table 500 assumes that a user's wanting a weighted ranking of the given vide data is searching for search term “social business”. In the depicted example, an overall weight of the given video is calculated as an average of the speaker's weight in the video, the weight of the content entity “Social Business” in the speaker's portion of the video data, and the weight of the content entity “Social Business” in the entire given video.

An embodiment allows further calibration of such weighting factor, such as by using constants, multipliers, ranges, thresholds, or other adjustments, to perform different weighted rankings differently for different purposes. For example, using table 500, an embodiment can rank a video differently based on which speaker is the person of interest to the user.

For example, a weighted ranking produced by an embodiment when the person of interest has a weight 7 will be different from the weighted ranking when the person of interest has a weight 5 or 3. As another example, an embodiment can perform the weighted ranking without considering the speaker's weight, or by using a default weight, e.g., 4, for the speaker.

Column 502 lists different persons or roles that can be expected in a given video. Column 504 lists the weights associated with the persons or roles of column 502. Column 506 lists a weight computed for a search term for a person or role of column 502 in the manner described with respect to FIG. 4. Column 508 lists a weight computed for a search term for the given video data as a whole in the manner described with respect to FIG. 4.

Column 510 lists an overall ranking weight of the video data in relation to the search term. For example, as depicted, column 510 in row 512 is a rounded average function of the values in columns 504, 506 and 508. Any suitable function can be used to compute the weights in columns 506, 508, or 510 within the scope of the illustrative embodiments.

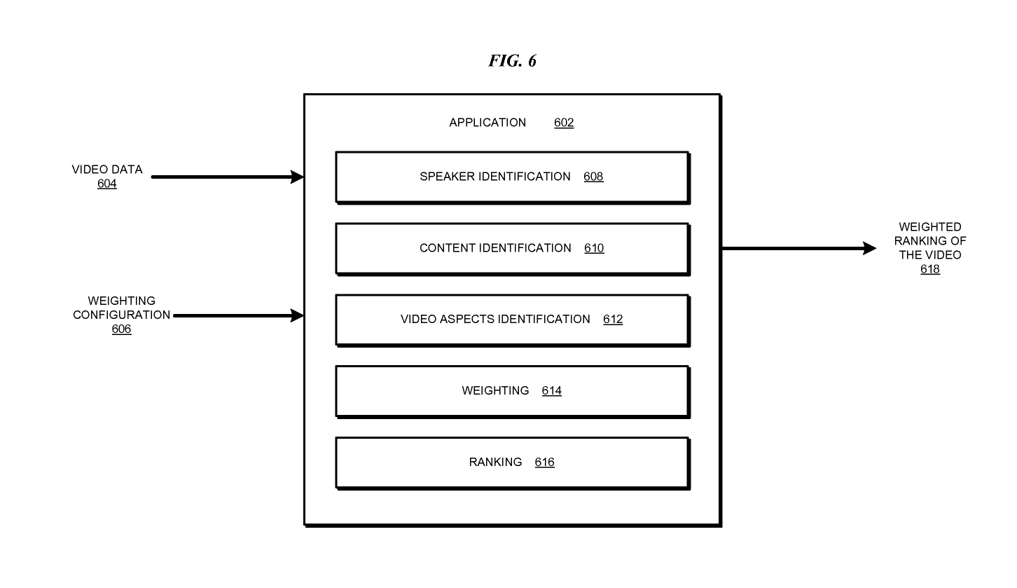

With reference to FIG. 6, this figure depicts a block diagram of an application for weighted ranking of video data in accordance with an illustrative embodiment. Application 602 can be used to perform the weighted rating of video data 604 in the manner described with respect to FIG. 5. Application 602 is analogous to application 103 in FIG. 1.

In addition to video data 604, application 602 receives as input weighting configuration 606. Speaker identification component 608 identifies persons or roles of interest in video data 604. For example component 608 may utilize images or other data (not shown) received from other sources described earlier. Content identification component 610 identifies content entities for use in weighted ranking of video data 604 in the manner described with respect to FIGS. 3, 4, and 5.

Video aspects identification component 612 identifies other aspects of video in video data 604. For example, component 612 may isolate background objects, persons, or artifacts; foreground objects, persons, or artifacts; a quality aspect of the video, such as noise, resolution, or shaking; a language of or in the video; a context of the video, such as a product campaign or a technology conference; access restrictions associated with the video, such as whether openly available or secured via some authentication; a role of the video, such as a business use or pleasure use; a type of the video, such as a conference video with one camera copy, or a concert video with versions from several cameras being available; and many other aspects.

Furthermore, while the embodiments in this disclosure are described using content entities and their relationship with persons or roles, an embodiment need not be so limited. Content entities are but one aspect among many aspects available in a given video. For example, an embodiment can be adapted to replace the content entities aspect with any other aspect of the video, including but not limited to the example aspects listed herein. The embodiment can then perform weighted ranking of the video using that aspect and its relationship with persons or roles in the video.

Additionally, an embodiment can be adapted to weight using any number of such aspects. For example, an embodiment can be configured, using this disclosure, to weight-rank a video for the presence or absence of a background object, a certain context, and more than one person or role.

Returning to FIG. 6, weighting component 614 performs the weighting described with respect to FIGS. 3, 4, and 5, and also the variations thereof using other aspects of video data 604 described above. Ranking component 616 computes the weighted ranking for video data 604 using the selected one or more aspects, such as described with respect to FIG. 5. Application 618 outputs weighted ranking 618 of video data 604 according to weighting configuration 606.

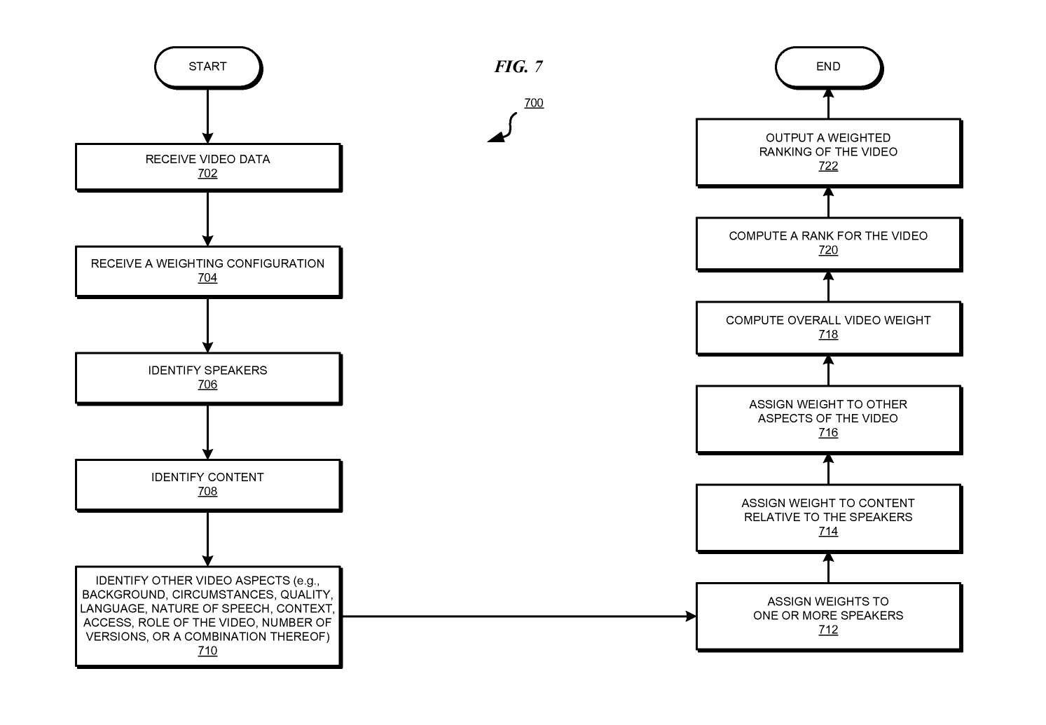

With reference to FIG. 7, this figure depicts a flowchart of an example process of weighted ranking of video data in accordance with an illustrative embodiment. Process 700 can be implemented in application 602 in FIG. 6.

Process 700 begins by receiving video data to be weight-ranked (step 702). Process 700 receives a weighting configuration (step 704).

Process 700 identifies the speakers, such as by identifying persons or roles present in the video data or expected in the video data (step 706). Process 700 identifies content, such as by identifying the content entities defined for the weighted ranking (step 708). Process 700 may also identify other vide aspects as described with respect to FIG. 6 (step 710).

Process 700 assigns weights to one or more speakers in the manner described with respect to FIGS. 3, 4, and 5 (step 712). Process 700 assigns weights to the content, such as by assigning weights to the content relative to one or more speakers (step 714). In a similar manner as step 714, process 700 may also assign weights to other one or more aspects of the video data (step 716).

Process 700 computes an overall weight for the video for a given search term, content entity, or another aspect as relates to one or more persons or roles in the video data (step 718). Using the weight computed in step 718, process 700 computes a ranking for the video data for the search term, content entity, another aspect, relative to one or more persons or roles present or expected in the video data (step 720). Process 700 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for weighted ranking of video data. Using an embodiment, video data can be analyzed, weighted, and ranked not only by the metadata statically defined for the video, but dynamically, using a weighting configuration prepared for the type of information a user may be interested in. The video data can be weight ranked for the presence or absence of certain aspects, including but not limited to content entities, in conjunction with persons or roles involved with the communication of those aspects. The searched aspects can be weighted based on their presence, absence, or frequency in the video data, their being communicated by persons that are assigned certain weights, and an overall weighting of the video data.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer implemented method for weighted ranking of a video data, the method comprising:
assigning a weight to an aspect of the video data;
assigning a weight to a person expected to feature in the video data;
computing a weight of the video data, the weight of the video data being a factor of the weight assigned the aspect and the weight assigned the person; and
computing a ranking of the video data using the weight computed for the video data.

2. The computer implemented method of claim 1, wherein the weighting configuration includes a manner of identifying the person in the video data.

3. The computer implemented method of claim 2, wherein the manner of identifying the person is by defining a role of the person.

4. The computer implemented method of claim 1, wherein the weight assigned to the aspect is indicative of a frequency of occurrence of the aspect in relation to the person in the video data.

5. The computer implemented method of claim 1, wherein the weight assigned to the aspect is indicative of a frequency of occurrence of the aspect being communicated by the person in the video data.

6. The computer implemented method of claim 1, wherein the aspect of the video data is a portion of the content, and wherein the portion is one of a word, a phrase, an object, an access criterion, a language, a quality parameter in the video data.

7. The computer implemented method of claim 1, wherein the aspect of the video data is a number of camera versions available for the video data.

8. The computer implemented method of claim 1, further comprising:
receiving the video data;
receiving the weighting configuration; and
presenting the ranking of the video data.

9. A computer usable program product comprising a computer usable storage medium including computer usable code for weighted ranking of a video data, the computer usable code comprising:
computer usable code for assigning a weight to an aspect of the video data;
computer usable code for assigning a weight to a person expected to feature in the video data;
computer usable code for computing a weight of the video data, the weight of the video data being a factor of the weight assigned the aspect and the weight assigned the person; and
computer usable code for computing a ranking of the video data using the weight computed for the video data.

10. The computer usable program product of claim 9, wherein the weighting configuration includes a manner of identifying the person in the video data.

11. The computer usable program product of claim 10, wherein the manner of identifying the person is by defining a role of the person.

12. The computer usable program product of claim 9, wherein the weight assigned to the aspect is indicative of a frequency of occurrence of the aspect in relation to the person in the video data.

13. The computer usable program product of claim 9, wherein the weight assigned to the aspect is indicative of a frequency of occurrence of the aspect being communicated by the person in the video data.

14. The computer usable program product of claim 9, wherein the aspect of the video data is a portion of the content, and wherein the portion is one of a word, a phrase, an object, an access criterion, a language, a quality parameter in the video data.

15. The computer usable program product of claim 9, wherein the aspect of the video data is a number of camera versions available for the video data.

16. The computer usable program product of claim 9, further comprising:
computer usable code for receiving the video data;
computer usable code for receiving the weighting configuration; and
computer usable code for presenting the ranking of the video data.

17. The computer usable program product of claim 9, wherein the computer usable code is stored in a computer readable storage medium in a data processing system, and wherein the computer usable code is transferred over a network from a remote data processing system.

18. The computer usable program product of claim 9, wherein the computer usable code is stored in a computer readable storage medium in a server data processing system, and wherein the computer usable code is downloaded over a network to a remote data processing system for use in a computer readable storage medium associated with the remote data processing system.

19. A data processing system for weighted ranking of a video data, the data processing system comprising:
a storage device including a storage medium, wherein the storage device stores computer usable program code; and
a processor, wherein the processor executes the computer usable program code, and wherein the computer usable program code comprises:
computer usable code for assigning a weight to an aspect of the video data;
computer usable code for assigning a weight to a person expected to feature in the video data;
computer usable code for computing a weight of the video data, the weight of the video data being a factor of the weight assigned the aspect and the weight assigned the person; and
computer usable code for computing a ranking of the video data using the weight computed for the video data.

20. The data processing system of claim 19, wherein the weighting configuration includes a manner of identifying the person in the video data.
